(19) United States
(12) Patent Application Publication
(10) Pub. No.: US 2004/0100049 A1
(43) Pub. Date: May 27, 2004

(54) Heated mechanic's creeper with voltage control

(76) Inventors: David W. Deasy, Horsham, PA (US); Roy S. Furey, Allentown, NJ (US)

Correspondence Address: Kenneth P. Glynn, Esq., Glynn & Associates, P.C., 24 Mine Street, Flemington, NJ, 08822, US

(21) Appl. No.: 10/401,161

(22) Filed: Mar. 27, 2003

Related U.S. Application Data
(63) Continuation-in-part of application No. 10/304,835, filed on Nov. 26, 2002.

(51) Int. Cl. B25H 5/00

(52) U.S. Cl. 280/32.6

(57) ABSTRACT

The present invention is a mechanic's creeper for operating under a vehicle. It includes a main frame with a plurality of wheels, and is adapted to receive at least a torso of an adult. The main frame has a rigid structure and a padded area for a user to lie on, face up. There is at least one heating element located at the padded area, either under the padded area or embedded in it. These pads may be removable or permanently attached to the frame. Connection is provided to the heating element and for connection to an AC voltage control component for connection to an AC power source. Or, alternatively, in addition, the present invention mechanic's creeper may further include a power source physically connected to the creeper and electrically connected to the connection, e.g. rechargeable or replaceable batteries.

### REFERENCE TO RELATED APPLICATION

This is a continuation-in-part of copending U.S. patent application Ser. No. 10/304,835 filed on Nov. 26, 2002, entitled “Heated Mechanic's Creeper,” by the same inventors herein.

### BACKGROUND OF THE INVENTION

1. Field of the Invention

The present invention relates to mechanic's creepers, also known as mechanic's dollies, which have heated pad area for heating the torso, or a portion thereof, of a user. More specifically, the heated mechanic's creepers of the present invention are adapted to include a voltage control component, which may be plugged into standard AC outlets, yet provide AC or DC low voltage power.

2. Information Disclosure Statement

The following patents illustrate prior art devices of mechanic's creepers or related devices:

U.S. Pat. No. 4,570,957 describes a mechanic's creeper having a bowed frame and a method for constructing the frame. The frame comprises a pair of parallel longitudinal rails of rectangular metal tubing bowed to form an arch for increased strength against vertical loads resting on the creeper. A plurality of metal cross members are welded to the underside of the longitudinal rails to form the frame. A creeper bed framed by wood or metal sheet, a headrest and castors for movement are attached to the frame. To construct the creeper frame, the longitudinal rails are fixed parallel to each other and the cross members welded in a predetermined sequential order across the underside of the frame. The sequential welding causes the metal of the underside of the longitudinal rails to expand as it is heated and then to contract as it cools to a length lo less than its original length to bow the rails lengthwise.

U.S. Pat. No. 4,909,524 describes a slider creeper that a person may lie on for working under vehicles, with the slider creeper having a back panel, having a interior surface for receiving a user and an exterior surface with upturned edges to permit the slider creeper to slide along a surface, with the back panel having a pivotal head rest for elevating and supporting a user's head when the user's weight is located on said back panel and a harness for mounting the slider creeper on the user's back.

U.S. Pat. No. 5,195, 763 describes a cushion for removable attachment to an automotive repair creeper and according to the preferred teachings of the present invention including a flexible insulator removably received within a flexible bag-like covering. The insulator in its preferred form includes first and second reflective layers sandwiching sealed, multiple air cell material. The reflective layers reflect body heat back and cold away from the mechanic. The air encapsulated in the air cells acts as insulation in reducing heat transfer and provides a resilient, cushion-type support. The cushion has a size and shape generally equal to and complementary to the top surface of the platform of the creeper between the longitudinal rails and is removably held thereon by fasteners which in the preferred form are VELCRO® fasteners secured to the bottom half of the covering and the top surface of the platform such as by double-sided adhesive tape whereby the insulator is located intermediate the platform and the mechanic laying thereon. Thus, the cushion may be secured to and removed from the creeper without the use of tools and without modification to the creeper.

U.S. Pat. No. 5,392,201 discloses a rolling mechanic's lamp. The lamp is provided with a rectangular frame member having a centrally located opening and two receptacles remote therefrom for carrying small tools and the like. A reflector is secured to the frame member for directing light through the top of the opening. An electric bulb, capable of illuminating the area above the frame member when energized, is supported by the reflector within the opening. A cage is secured to the top of the frame member and disposed above the bulb. The cage includes a ring fitted about the periphery of the opening and a number of arches having their respective upper ends joined together at a predetermined height above the opening. A caster is secured to each of the four corners of the frame member. A handle is joined to one side of the frame member for grasping by the human hand and movement of the lamp from place to place.

Notwithstanding the prior art, the present invention is neither taught nor rendered obvious thereby.

### SUMMARY OF THE INVENTION

The present invention is a mechanic's creeper for operating under a vehicle. It includes a main frame with a plurality of wheels, and adapted to receive at least a torso of an adult. The main frame has a rigid structure and a padded area for a user to lie on, face up. There is at least one heating element located at the padded area, either under the padded area or embedded in it. These pads may be removable or permanently attached to the frame.

Connection means is provided to the heating element and for connection to a voltage control component, which, itself is connected to an AC power source. The connection means may be a wire and plug for connection to the voltage control component, or a wire that is permanently connected to the voltage control component. The voltage control component is adapted to reduce voltage from an AC power source as to provide a lower, safer voltage level. It has been recognized that typical voltages of 110 and 220 AC power sources may kill if accidents human exposure occurs. Additionally softly regulations and/or governmental regulations may require lower voltage in floor areas and other high risk areas. For these reasons, the present invention voltage regulation components would reduce voltage to lower than 60 volts in some preferred embodiments. Voltage as low as 55 volts or 45 volts or so 1 or even regulators down to 24 of 12 volts, may be used. These regulators may be step down devices single voltage regulators, multiple step down regulators or transformers. Preferred are single step down voltage regulators.

In some preferred embodiments, the present invention mechanic's creeper main frame includes a wire support that protrudes outwardly from the main frame. This may be a coiled, springy wire to hold the plug or connection wire to keep it off the floor in the immediate area of the creeper wheels.

The mechanic's creeper of the present invention may typically have four wheels or six wheels attached to the frame, but within the scope of the present invention, may have any functional number of wheels, or equivalent movement/support members, e.g. treads or skids. The main frame may be of any desired shape, and is preferably rectangular in shape and may be formed, at least in part, of hollow tubing, e.g. metal or plastic.

In some embodiments, the present invention mechanic's creeper padded area may include a headrest padded area and a torso padded area, and the heating element is located at least at the torso padded area, e.g. under the torso padded area, or embedded within the torso padded area.

The present invention mechanic's creeper of preferably includes a controller for the heating element, and this may have conventional heating pad controls, i.e. on/off switch, and, in some models, hi-low, or variable power settings. The controller would be wired to function with an additional voltage regulator(s) in those embodiments having different heat levels.

### BRIEF DESCRIPTION OF THE DRAWINGS

The present invention should be more fully understood when the specification herein is taken in conjunction with the drawings appended hereto wherein:

FIG. 1 shows a top view, and

FIG. 2 shows a partial side cut view, of a present invention, heated mechanic's creeper;

FIG. 3 shows a partial cut top view of an alternative embodiment present invention mechanic's creeper having an on-board, rechargeable power source;

FIG. 4 shows a top view of another embodiment of a present invention mechanic's creeper; and,

FIG. 5 shows a schematic diagram of a present invention device.

### DETAILED DESCRIPTION OF THE PRESENT INVENTION

Mechanics spend many hours each week under vehicles, typically on a mechanic's creeper. Because garages often have concrete or other cold, hard flooring, these work conditions are often colder than normal workplace conditions. Exacerbated by opening and closing of garage doors in cold weather, coupled with the fact that heat rises and garage heating is not floor located, the health of these mechanics may be at stake. Further, many mechanics operate with creepers in outdoor situations, even in colder weather. Colds, sore backs, arthritis, low back, and intestinal problems, etc. may be caused, at least in part, by working in a cold environment with the back to the floor or ground. Further, discomfort from the cold causes inefficiencies, warm-up breaks, distractions, job dissatisfaction, etc.

The present invention mechanic's creeper is directed to overcoming many of the foregoing problems, by offering heat and comfort to the user in cold environments, especially in the torso (back and butt) areas.

FIG. 1 shows a top view of a present invention mechanic's creeper 1. It includes a main frame 3. This main frame 3 could be made of metal, wood, heavy duty plastic or combinations. The main frame 3 has a top 5, a bottom 7 and sides 9 and 11, as well as a padding support panel (under pads 21 and 23), not shown, but connected to and supported by the top 5, bottom 7 and side 9 and 11.

Wheels 13, 15, 17 and 19 are connected to the main frame 3 and may be casters or other types of wheels. Typically, six wheels are utilized, but four are shown here for simplicity. There are two pads in this model. Head pad 21 is located at top 5 and torso pad 23 is below it. Either imbedded in pad 23 or located under it is heating coil 25. Pad 23 is partially cut to show heating coil 25.

Heating coil 25 is located so as to provide heat to the back and butt of a user when laying on it. Heating coil 25 is connected to controller 27 and then to a wire 29 and a plug 31. Plug 31 may be connected to voltage control component 41, which in turn may be plugged into any AC outlet via plug 43. Alternatively, wire 24 could be permanently connected to voltage control component 43. When plug 43 is inserted into a conventional AC power outlet, and plug 31 is inserted into voltage control component 41, the power into component 41 is approximately 110 volts and component 41 may reduce this to, for example, 45 volts or 12 volts to operate the heating coil 25 via controller 27.

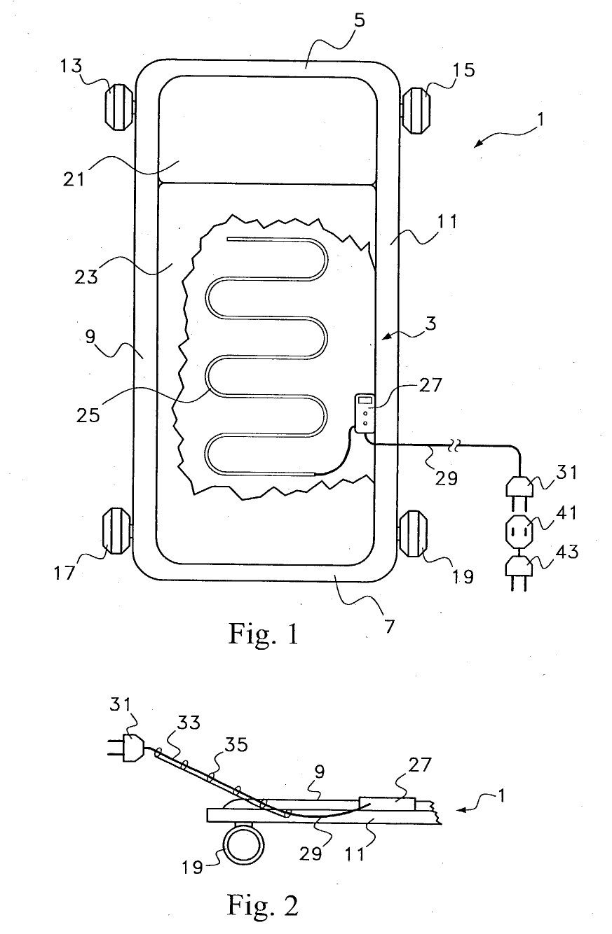

FIG. 2 shows a side cut view of a lower portion of creeper 1 from FIG. 1, and identical elements are identically numbered. In this FIG. 2 version, creeper 1 has been modified to include a protrusion such as a coil spring or rod for supporting the wire and plug. Thus, rod 33 is connected to frame side 11 so as to extend therefrom outwardly and slightly upwardly to hold the wire 29 from accidentally impeding movement of creeper 1 and eliminates otherwise possible wheel entanglement, as well.

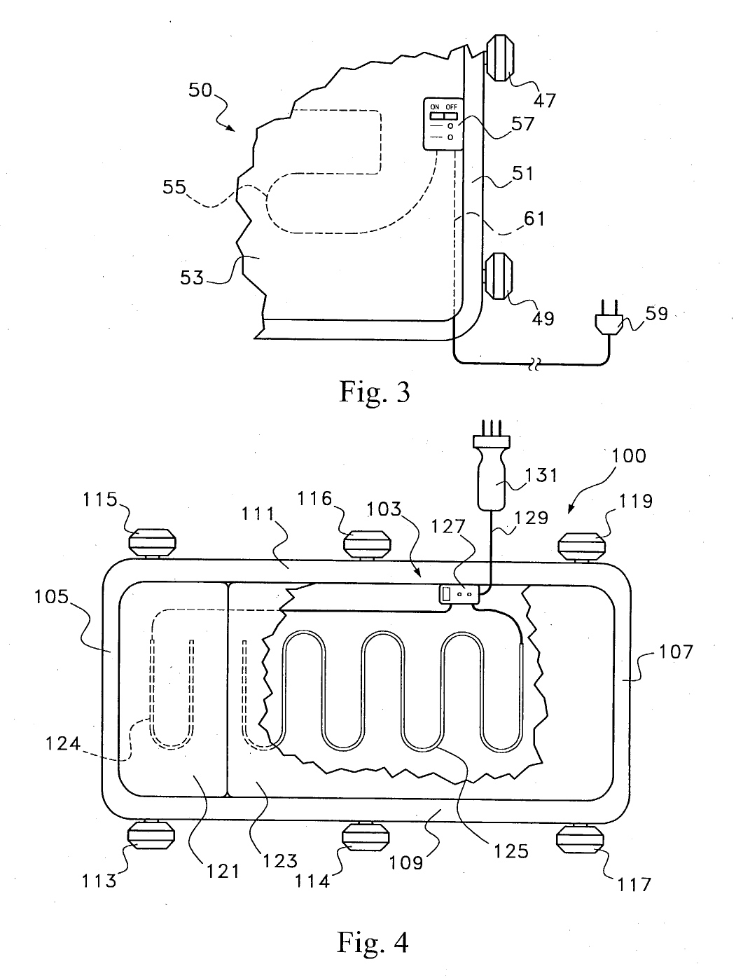

FIG. 3 illustrates a top partial view of a corner of another embodiment of the present invention. Creeper 50 is a six wheel mechanic's creeper, with two wheels 47 and 49 showing, attached to frame 51. There is a torso pad 53 and a heating coil 55 embedded therein (or located thereunder). Controller 57 includes a voltage regulator and is connected to coil 55 and to wire 66, which is permanently connected to voltage control component 59. This is plugged into an outlet and provides 24 volt DC power to the controller 57. Controller 57 includes an ON/OFF switch and Hi and LOW settings.

FIG. 4 shows a top view of another present invention mechanic's creeper 100. It includes a main frame 103 with sidewalls 109 and 111, front 105 and back 107. There are supporting cross bars and a base (not shown) under head pad 121 and torso pad 123. There are six swivel wheels 113, 114, 115, 116, 117, and 119 attached to the main frame. Heating elements 124 and 125 are located at the head pad 121 and the torso pad 123, respectively. They are separately connected to controller 127. In this embodiment, wire 129 is connected to a voltage control component 131 with a three pronged 220 volt AC plug. The component 131 reduces the age down to 24 volts DC, for powering the heating costs.

FIG. 5 shows a schematic flow diagram of the general concept for the present invention heated mechanic's creeper. An AC power source 201 provides power to voltage control component 202. The voltage control component reduces the voltage to a safe level and may preferably also convert the voltage to direct current. A connection 203 then provides the reduced voltage power to the heating coil controller 205 and/or to optional battery 204 for powering heating coils 206 located in the present invention creeper device. The heating coil controller 205 could be an off/on switch or voltage regulation for high and low settings or any other typical heating pad control element or features.

Obviously, numerous modifications and variations of the present invention are possible in light of the above teachings. It is therefore understood that within the scope of the appended claims, the invention may be practiced otherwise than as specifically described herein.

What is claimed is:

1. A mechanic's creeper for operating under a vehicle, which comprises:
(a) a main frame adapted to receive at least a torso of an adult, said main frame having a rigid structure and a padded area;
(b) a plurality of wheels attached to said main frame;
(c) at least one heating element located at said padded area;
(d) connection means to said at least one heating element and to a voltage control component;
(e) voltage control component connected to said connection means, said voltage control component having a plug for connection to an AC power source, and having control means contained therein to reduce voltage from said AC power source to said connection means.

2. The mechanic's creeper of claim 1 wherein said connection means is a wire and plug for connection to voltage control component.

3. The mechanic's creeper of claim 1 wherein said connection means is a wire connected directly to said voltage control component.

4. The mechanic's creeper of claim 1 wherein said voltage control component includes voltage control means to reduce voltage to said connection means to a level not greater than 60 volts.

5. The mechanic's creeper of claim 1 wherein said mechanic's creeper voltage control component further includes voltage adjustment means to permit selection of more than one voltage setting.

6. The mechanic's creeper of claim 1 wherein said voltage control component provides AC current to said connection means and said heating element is adapted to operate on AC current.

7. The mechanic's creeper of claim 1 wherein said voltage control component provides DC current to said connection means and said heating element is adapted to operate on DC current.

8. The mechanic's creeper of claim 2 wherein said main frame includes a wire support that protrudes outwardly from said main frame.

9. The mechanic's creeper of claim 3 wherein said main frame includes a wire support that protrudes outwardly from said main frame.

10. The mechanic's creeper of claim 4 wherein said main frame includes a wire support that protrudes outwardly from said main frame.

11. The mechanic's creeper of claim 1 wherein said at least one heating element is located under said padded area.

12. The mechanic's creeper of claim 1 wherein said at least one heating element is imbedded within said padded area.

13. The mechanic's creeper of claim 11 wherein said padded area includes a removable pad member.

14. The mechanic's creeper of claim 12 wherein said padded area includes a removable pad member.

15. The mechanic's creeper of claim 1 wherein said main frame is a metal main frame, and there are at least four wheels attached thereto.

16. The mechanic's creeper of claim 1 wherein said main frame is rectangular in shape and is formed, at least in part, of hollow tubing.

17. The mechanic's creeper of claim 1 wherein said padded area includes a headrest padded area and a torso padded area, and said at least one heating element is located at said torso padded area.

18. The mechanic's creeper of claim 17 wherein said at least one heating element is located under said torso padded area.

19. The mechanic's creeper of claim 17 wherein said at least one heating element is embedded within said torso padded area.

20. The mechanic's creeper of claim 1, which further includes a controller for said at least one heating element.
